(19) United States
(12) Patent Application Publication
(10) Pub. No.: US 2026/0333196 A1
(43) Pub. Date: Oct. 22, 2026

(54) TRANSMISSION OF TIME-INVARIANT AND TIME-VARIANT INFORMATION VIA SEPARATE CHANNELS

(71) Applicant: Lenovo (United States) Inc., Morrisville, NC (US)

(72) Inventor: Karthikeyan Ganesan, Nauheim (DE)

(73) Assignee: Lenovo (United States) Inc., Morrisville, NC (US)

(21) Appl. No.: 19/573,488

(22) Filed: Mar. 20, 2026

(51) Int. Cl. H04W 48/08; H04L 5/00; H04W 48/20

(52) U.S. Cl. CPC H04W 48/08; H04L 5/0051; H04W 48/20

(57) ABSTRACT

Various aspects of the present disclosure relate to transmission of time-invariant and time-variant information via separate channels. An apparatus, such as a user equipment (UE), receives, via a first channel (e.g., a physical broadcast channel (PBCH)), a first payload including time-invariant information associated with a master information block (MIB). The first channel is associated with a demodulation reference signal (DMRS) that is common for a set of m synchronization signal block (SSB) beam, and a network equipment (NE) transmits the first payload in the set of SSB beams. Additionally, the UE receives, via a second channel (e.g., a PBCH), a second payload including time-variant information associated with the MIB. The NE transmits the second payload in at least one of a subset of the set of SSB beams, a beam wider than each beam of the set of SSB beams, or a number of repetitions.

### TECHNICAL FIELD

The present disclosure relates to wireless communications, and more specifically to the transmission of time-invariant and time-variant information via separate channels.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive, via a first channel, a first payload including time-invariant information associated with a master information block (MIB), where the first channel is associated with a demodulation reference signal (DMRS) that is common for a set of SSB beams, and where the first payload is transmitted in each beam of the set of SSB beams; and receive, via a second channel, a second payload including time-variant information associated with the MIB, where the second payload is transmitted in at least one of a subset of the set of SSB beams, a beam wider than each beam of the set of SSB beams, or a number of repetitions.

A processor (e.g., a standalone processor chipset, or a component of a UE) for wireless communication is described. The processor may be configured to, capable of, or operable to perform one or more operations as described herein. For example, the processor may be configured to, capable of, or operable to receive, via a first channel, a first payload including time-invariant information associated with an MIB, where the first channel is associated with a DMRS that is common for a set of SSB beams, and where the first payload is transmitted in each beam of the set of SSB beams; and receive, via a second channel, a second payload including time-variant information associated with the MIB, where the second payload is transmitted in at least one of a subset of the set of SSB beams, a beam wider than each beam of the set of SSB beams, or a number of repetitions.

A method performed or performable by a UE for wireless communication is described. The method may include receiving, via a first channel, a first payload including time-invariant information associated with an MIB, where the first channel is associated with a DMRS that is common for a set of SSB beams, and where the first payload is transmitted in each beam of the set of SSB beams; and receiving, via a second channel, a second payload including time-variant information associated with the MIB, where the second payload is transmitted in at least one of a subset of the set of SSB beams, a beam wider than each beam of the set of SSB beams, or a number of repetitions.

In some implementations of the UE, the processor, and the method described herein, a first set of multiple time-frequency resources are used to receive the first payload and a second set of multiple time-frequency resources are used to receive the second payload based on a synchronization signal block (SSB) structure. In some implementations of the UE, the processor, and the method described herein, the first payload is frequency division multiplexed (FDM) with the second payload in a same set of symbols.

In some implementations of the UE, the processor, and the method described herein, the UE, the processor, and the method may further be configured to, capable of, operable to, performed to, or performable to receive a set of multiple instances of the second payload at an end of an SSB burst, where a first instance of the second payload is associated with a first SSB beam and a first SSB occasion and a second instance of the second payload is associated with a second SSB beam and a second SSB occasion.

In some implementations of the UE, the processor, and the method described herein, the UE, the processor, and the method may further be configured to, capable of, operable to, performed to, or performable to perform non-coherent combining of the first payload received via the set of SSB beams based on the DMRS being common for the set of SSB beams. In some implementations of the UE, the processor, and the method described herein, the second payload is received via an anchor beam associated with one or more SSB beams of the set of SSB beams. In some implementations of the UE, the processor, and the method described herein, the UE, the processor, and the method may further be configured to, capable of, operable to, performed to, or performable to determine the anchor beam based on an SSB index and a beam group size.

In some implementations of the UE, the processor, and the method described herein, the second payload is received at an end of an SSB burst set via a wider beam than a beam used for reception of the first payload, and the UE, the processor, and the method may further be configured to, capable of, operable to, performed to, or performable to decode the time-invariant information based on receiving the first payload; and switch to a quasi-omni reception mode to receive the second payload.

In some implementations of the UE, the processor, and the method described herein, the UE, the processor, and the method may further be configured to, capable of, operable to, performed to, or performable to receive the time-variant information via a system information block (SIB), and where the SIB further includes at least one of cell quality information, access control information, or paging information. In some implementations of the UE, the processor, and the method described herein, the UE, the processor, and the method may further be configured to, capable of, operable to, performed to, or performable to perform cell selection based on the time-invariant information without decoding the time-variant information.

In some implementations of the UE, the processor, and the method described herein, the first channel and the second channel are coded with different code rates and different channel coding schemes. In some implementations of the UE, the processor, and the method described herein, the second channel indicates an SSB beam index for the set of SSB beams via a bitmap field or a codepoint field.

In some implementations of the UE, the processor, and the method described herein, the UE, the processor, and the method may further be configured to, capable of, operable to, performed to, or performable to receive, via the set of SSB beams, a configuration indicating a control resource set (CORESET) common to the set of SSB beams; and receive an SIB via the CORESET, where the SIB is received in a beam that is wider than the set of SSB beams. In some implementations of the UE, the processor, and the method described herein, the second channel is associated with a lower code rate than the first channel.

An NE for wireless communication is described. The NE may be configured to, capable of, or operable to perform one or more operations as described herein. For example, the NE may be configured to, capable of, or operable to transmit, via a first channel, a first payload including time-invariant information associated with an MIB, where the first channel is associated with a DMRS that is common for a set of SSB beams, and where the first payload is transmitted in each beam of the set of SSB beams; and transmit, via a second channel, a second payload including time-variant information associated with the MIB, where the second payload is transmitted in at least one of a subset of the set of SSB beams, a beam wider than each beam of the set of SSB beams, or a number of repetitions.

A processor (e.g., a standalone processor chipset, or a component of an NE) for wireless communication is described. The processor may be configured to, capable of, or operable to perform one or more operations as described herein. For example, the processor may be configured to, capable of, or operable to transmit, via a first channel, a first payload including time-invariant information associated with an MIB, where the first channel is associated with a DMRS that is common for a set of SSB beams, and where the first payload is transmitted in each beam of the set of SSB beams; and transmit, via a second channel, a second payload including time-variant information associated with the MIB, where the second payload is transmitted in at least one of a subset of the set of SSB beams, a beam wider than each beam of the set of SSB beams, or a number of repetitions.

A method performed or performable by an NE for wireless communication is described. The method may include transmitting, via a first channel, a first payload including time-invariant information associated with an MIB, where the first channel is associated with a DMRS that is common for a set of SSB beams, and where the first payload is transmitted in each beam of the set of SSB beams; and transmitting, via a second channel, a second payload including time-variant information associated with the MIB, where the second payload is transmitted in at least one of a subset of the set of SSB beams, a beam wider than each beam of the set of SSB beams, or a number of repetitions.

In some implementations of the NE, the processor, and the method described herein, a first set of multiple time-frequency resources are used to transmit the first payload and a second set of multiple time-frequency resources are used to transmit the second payload based on an SSB structure. In some implementations of the NE, the processor, and the method described herein, the first channel is FDM with the second channel in a same set of symbols.

In some implementations of the NE, the processor, and the method described herein, the NE, the processor, and the method may further be configured to, capable of, operable to, performed to, or performable to transmit a set of multiple instances of the second payload at an end of an SSB burst, where a first instance of the second payload is associated with a first SSB beam and a first SSB occasion and a second instance of the second payload is associated with a second SSB beam and a second SSB occasion.

In some implementations of the NE, the processor, and the method described herein, the second payload is transmitted via an anchor beam associated with one or more SSB beams of the set of SSB beams. In some implementations of the NE, the processor, and the method described herein, the anchor beam is based on an SSB index and a beam group size.

In some implementations of the NE, the processor, and the method described herein, the second payload is transmitted at an end of an SSB burst set via a wider beam than a beam used for transmission of the first payload. In some implementations of the NE, the processor, and the method described herein, the NE, the processor, and the method may further be configured to, capable of, operable to, performed to, or performable to transmit the time-variant information via an SIB, and where the SIB further includes at least one of cell quality information, access control information, or paging information.

In some implementations of the NE, the processor, and the method described herein, the first channel and the second channel are coded with different code rates and different channel coding schemes. In some implementations of the NE, the processor, and the method described herein, the second payload indicates an SSB beam index for the set of SSB beams via a bitmap field or a codepoint field.

In some implementations of the NE, the processor, and the method described herein, the NE, the processor, and the method may further be configured to, capable of, operable to, performed to, or performable to transmit, via the set of SSB beams, a configuration indicating a control resource set (CORESET) common to the set of SSB beams; and transmit an SIB via the CORESET, where the SIB is transmitted in a beam that is wider than the set of SSB beams. In some implementations of the NE, the processor, and the method described herein, the second channel is associated with a lower code rate than the first channel.

### BRIEF DESCRIPTION OF THE DRAWINGS

FIG. 1 illustrates an example of a wireless communications system in accordance with aspects of the present disclosure.

FIGS. 2 and 3 illustrate examples of SSB structures in accordance with aspects of the present disclosure.

FIG. 4 illustrates an example of a signaling diagram, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, the NE may transmit system information to UEs, which may enable the UEs to access the network and perform various operations such as cell selection, synchronization, and initial access. An MIB is a type of system information that carries parameters for a UE to acquire further system information and access a network. An NE may transmit an MIB via a physical broadcast channel (PBCH), and the MIB may include both time-invariant information (e.g., configuration parameters that remain constant over time) and time-variant information (e.g., information that may vary over time).

In beamformed systems, the NE may transmit the MIB across multiple beams to provide coverage in different directions, with each beam associated with an SSB. However, transmitting the entire MIB payload, including both time-invariant and time-variant information, in each beam may result in inefficiencies. For example, a UE may need to decode the MIB from a single beam, which may limit opportunities for combining received signals across multiple beams to improve decoding reliability. Additionally, the time-variant information may change frequently, requiring the UE to decode the MIB each time, and obtain updated timing information, even when the time-invariant information remains unchanged. Without mechanisms to separate the transmission of time-invariant and time-variant information, the UE may experience reduced coverage, increased decoding complexity, and inefficient use of resources, particularly in scenarios in which link budgets may be constrained (e.g., scenarios involving non-terrestrial networks (NTNs) or high-frequency bands).

As described herein, to address the challenges of transmitting MIB information efficiently across multiple beams, a UE and an NE may support transmission of time-invariant and time-variant information via separate channels. Specifically, the NE may transmit, via a first channel, a first payload including time-invariant information associated with an MIB, where the first channel may be associated with a DMRS that is common for a set of SSB beams. The NE may transmit the first payload in each beam of the set of SSB beams. The NE may also transmit, via a second channel, a second payload including time-variant information associated with the MIB. The NE may transmit the second payload in at least one of a subset of the set of SSB beams, a beam wider than each beam of the set of SSB beams, or a number of repetitions.

By performing the described techniques, devices (e.g., a UE and an NE) in a wireless communications system may provide for improved coverage, reduced decoding complexity, and more efficient use of resources. For example, the use of a common DMRS across multiple beams for the first channel carrying time-invariant information may enable the UE to perform non-coherent combining of the first payload received via the set of SSB beams, thereby improving decoding reliability and extending coverage, particularly in scenarios involving constrained link budgets (e.g., scenarios involving NTNs or high-frequency bands). Additionally, the separation of time-invariant information and time-variant information into different channels may enable the UE to perform cell selection based on the time-invariant information without decoding the time-variant information, reducing decoding complexity and latency during initial access procedures. The transmission of the second payload via a wider beam, a subset of beams, or a number of repetitions may enable the NE to reduce overhead associated with transmitting time-variant information in each beam while maintaining coverage for the time-variant information. Additionally, the use of different code rates and different channel coding schemes for the first channel and the second channel may enable optimization of each channel for its respective payload characteristics, with the second channel associated with a lower code rate to improve reliability for the time-variant information.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

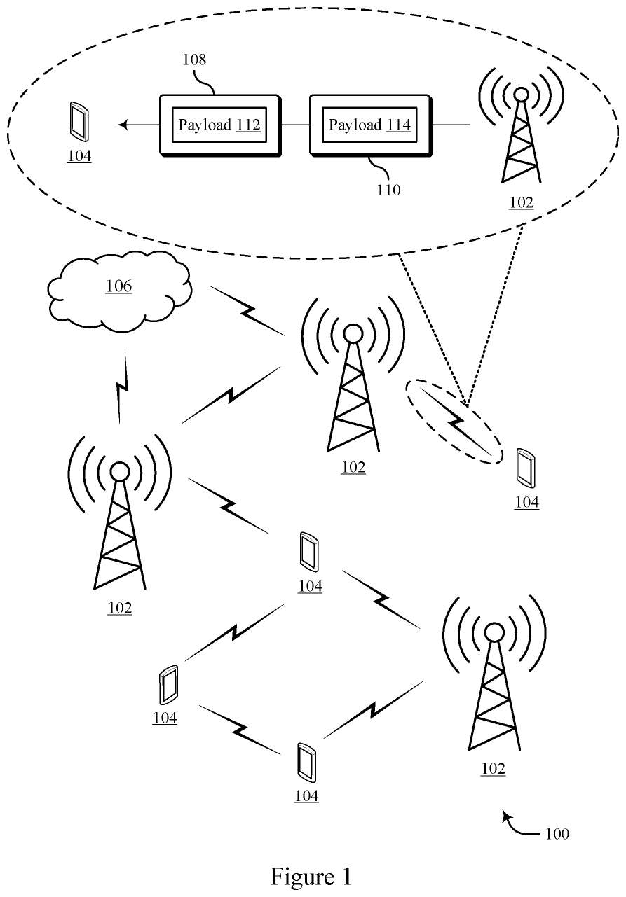

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may pose various challenges. For example, emissions and energy consumption from various elements of the system may contribute adversely to the climate. Additionally, operating expenses to run the wireless communications system 100 may be large, and as such, several industry-specific factors rooted in countering rising network costs further shape efficiency efforts. A continued rise in mobile data traffic is also forecast to continue growing on a per-user basis, which combined with the rising costs of spectrum, capital investment, and ongoing RAN maintenance and upgrades, increases the desire for energy-saving measures in network operations. 5G NR may offer energy-efficiency improvements per gigabyte over previous generations of mobility. However, some 5G use cases and the adoption of millimeter-Wave (mmW) communications may require more sites and antennas. This may lead to a more efficient network that may actually result in higher emissions without active intervention.

In some examples, network energy saving, particularly in NR, is of great importance for improving environmental sustainability, reducing environmental impact (e.g., greenhouse gas emissions), and saving operational costs. As 5G is becoming more pervasive across industries and geographical areas, handling more advanced services and applications requiring very high data rates (e.g., extended reality (XR)), networks are becoming denser, using more antennas, larger bandwidths, and more frequency bands. Solutions to improve network energy savings are desired to reduce the environmental impact of 5G. Energy consumption has become a key part of the operators' operational expenses. Most of such energy consumption may come from the RAN, and in particular, from Active Antenna Units (AAUs), with data centers and fiber transport accounting for a smaller share. The power consumption of a radio access may be split into two parts: a dynamic part, which is only consumed when data transmission/reception is ongoing, and a static part, which is consumed at all times to maintain the necessary operation of the radio access devices, even when the data transmission/reception is not ongoing.

As such, there is a need to develop a network energy consumption model, key performance indicators (KPIs), and an evaluation methodology, and to identify and study network energy savings techniques in targeted deployment scenarios. For example, it may be beneficial to achieve more efficient operation dynamically and/or semi-statically and finer granularity adaptation of communications in one or more network energy saving techniques in time, frequency, spatial, and power domains, with potential support and feedback from a UE 104, UE assistance information, and information exchange and coordination over network interfaces.

Additionally, 5G NR supports a uniform distribution of channels and signals (e.g., for 20 ms), which do not require slot format adjustment. However, 6G supports clustering of common channels and signals, resulting in non-uniform transmission of 6G common channels and signals, such as SSB, SIBx, paging, random access channel (RACH), and so forth. Such clustering of channels and signals may be performed using two clustering approaches, per-beam clustering or per-burst clustering. Clustering may utilize a change in slot format to enable consecutive downlink and/or uplink slots when associated downlink common channels and signals or uplink channels are transmitted respectively. Otherwise, the clustering may result in a gap between channels and signals, further leading to gaps that may prohibit an NE 102 from entering an early sleep mode. As such, a solution to enable slot format awareness during clustering of common channels and signals is desired, which may affect network energy savings, UE performance, and user experience with respect to sync signal(s) periodicities of 20 ms and longer, at least for initial access. In some examples, such solutions may enable NE 102 support of cell-common signaling (e.g., sync signal(s), broadcast physical downlink control channel (PDCCH), SIB-1, SIB, paging, physical random access channel (PRACH)), clustered provisioning of different cell-common signaling, on-demand provisioning of different cell-common signaling, and UE-specific signaling (e.g., for low, light, medium loads), including clustered provisioning with cell-common signaling and unclustered provisioning with cell-common signaling. Impacts on a UE 104 may include cell search complexity and latency, including frequency search latency, UE power consumption, sync signal detection, coverage and tracking performance, and radio resource management (RRM), mobility, and beam management (where other properties may not be precluded). To address such UE 104 impacts, the solution may include improvements such as additional sync signal capabilities, adaptation of sync signal transmission periodicity, and sparser sync raster.

In some examples, some channels and signals may be repeatedly transmitted within a beam (e.g., PBCH, SIB1) to improve coverage. However, such repeated transmission within a cluster period may increase a cluster duration and affect energy savings. The cross-beam combining of these channels and signals may be considered however, and any time-variant field within the channels and signals may be avoided to enable non-coherent (e.g., log-likelihood ratio (LLR)) combining of the channels and signals. However, some techniques may lack support for how and where to transmit such time-variant fields efficiently.

5G NR supports various time-variant fields such as a system frame number (SFN), a beam index (e.g., SSB index), and so forth, making the cross-beam PBCH combining difficult to achieve. If supported, cross-beam PBCH combining may reduce the number of PBCH repetitions, improving efficiency and reducing signaling overhead. As such, the techniques described herein support the separation of time-variant and time-invariant fields in an MIB to improve the efficiency of cross-beam combining while enabling transmission of both the time-variant and time-invariant fields.

According to implementations, one or more of the NEs 102 and the UEs 104 are operable to implement various aspects of the techniques described with reference to the present disclosure. For example, a UE 104 and an NE 102 may support transmission of time-invariant and time-variant information via separate channels. Specifically, the NE 102 may transmit, via a first channel 108 (e.g., a PBCH), a first payload 112 including time-invariant information associated with an MIB, where the first channel 108 may be associated with a DMRS that is common for a set of SSB beams. The NE 102 may transmit the first payload 112 in each beam of the set of SSB beams. The NE 102 may also transmit, via a second channel 110 (e.g., a PBCH), a second payload 114 including time-variant information associated with the MIB. The NE 102 may transmit the second payload 114 in at least one of a subset of the set of SSB beams, a beam wider than each beam of the set of SSB beams, or a number of repetitions.

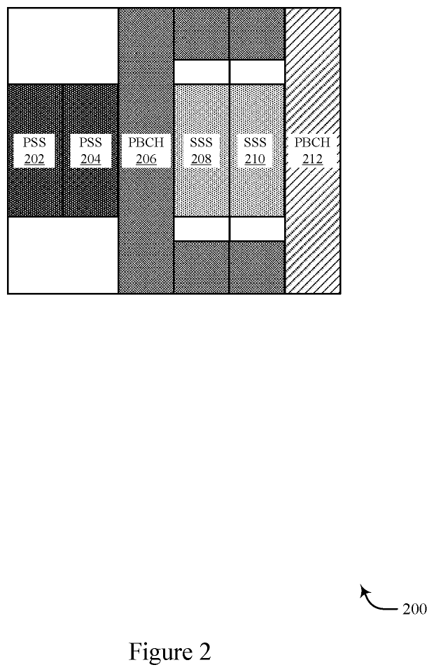

FIG. 2 illustrates an example of an SSB structure 200 in accordance with aspects of the present disclosure. The SSB structure 200 may implement or be implemented by aspects of the wireless communications system 100 and support the transmission of time-invariant and time-variant information via separate channels. The SSB structure 200 may include a primary synchronization signal (PSS) 202 and a PSS 204, which a UE may use to perform initial synchronization with an NE. Additionally, the SSB structure 200 may include a PBCH 206 (e.g., a first channel), a secondary synchronization signal (SSS) 208, an SSS 210, and a PBCH 212 (e.g., a second channel).

As described herein, time-variant information (e.g., one or more time-variant fields) of an MIB may be removed from the MIB and separately transmitted in a channel (e.g., a PBCH), in an anchor beam, or a combination thereof. That is, the PBCH may carry only remaining time-invariant information (e.g., one or more time-invariant fields) with common DMRS across a group of beams to enable cross-beam combining. The NE may then transmit the time-variant fields in a separate channel or signal with a lower code rate (e.g., 1/15 in a wider beam).

In the example of the SSB structure 200, a PBCH may be split into two channels, the PBCH 206 and the PBCH 212, to enable efficient transmission of MIB information across multiple beams. The PBCH 206, which may be referred to herein as a static PBCH (PBCH-S), may carry a first payload including time-invariant (e.g., static) information associated with the MIB. The time-invariant information may include configuration parameters that remain constant over time. In some examples, the PBCH 206 may be associated with a DMRS that is common for a set of SSB beams (e.g., SSB beams), and an NE may transmit the first payload in each beam of the set of SSB beams. The use of a common DMRS across the set of SSB beams may enable the UE to perform non-coherent combining of the first payload received via the set of SSB beams, which may improve decoding reliability and extend coverage, particularly in scenarios involving constrained link budgets.

The PBCH 212, which may be referred to as a dynamic PBCH (PBCH-D), may carry a second payload including time-variant (e.g., dynamic) information associated with the MIB. The time-variant information may include information that varies over time, such as an SFN, a half-frame indicator, an SSB index, and the like. The PBCH 212 may be associated with a lower code rate than the PBCH 206, which may improve reliability for the time-variant information through enhanced error correction capability at a receiving UE. The NE may transmit the second payload in at least one of a subset of the set of SSB beams, a beam wider than each beam of the set of SSB beams, or a number of repetitions. In some implementations, the NE may transmit the second payload in an anchor beam associated with one or more SSB beams of the set of SSB beams. The anchor beam may be determined based on an SSB index and a beam group size. Alternatively, the NE may transmit the time-variant information via an SIB, where the SIB may further include at least one of cell quality information, access control information, paging information, or the like.

The MIB may include various time-invariant and time-variant fields applicable to 5G NR, such as the fields shown in Table 1. For example, the time-invariant fields may include subCarrierSpacingCommon, ssb-SubcarrierOffset, dmrs-TypeA-Position, pdcch-ConfigSIB1, cellBarred, intraFreqReselection, and so forth. The time-variant fields may include an SFN, a half-frame indicator, an SSB index, PBCH DMRS scrambling, and so forth.

TABLE 1
Time-variant and time-invariant information for 5G NR

| | Number | |
|---|---|---|
| | of Bits | Time Variant? |
| MIB Content | | |
| system FrameNumber | 6 bits | Yes- changes every 10 ms |
| subCarrierSpacingCommon | 1 bit | NO - static cell parameter |
| ssb-SubcarrierOffset | 4 bits | NO - static cell parameter |
| dmrs-TypeA-Position | 1 bit | NO - static cell parameter |
| pdcch-ConfigSIB1 | 8 bits | NO - quasi-static |
| cellBarred | 1 bit | NO - quasi-static |
| intraFreqReselection | 1 bit | NO - quasi-static |
| PBCH Appended Bits | | |
| (9 bits beyond MIB) | | |
| SFN | 4 bits | Yes - changes every 10 ms |
| Half-frame indicator | 1 bit | Yes - changes every 5 ms |
| SSB index | 3 bits | Yes - beam specific |
| PBCH DMRS scrambling | | Yes - SSB index, SFN, half- |
| | | frame |

In some examples, PBCH DMRS sequence initialization may depend on the UE detecting a DMRS sequence and extracting three least significant bits (LSBs) of an SSB index. The remaining three most significant bits (MSBs) of the SSB index may be carried inside the second payload in the PBCH 212, which may include the MIB. That is, the PBCH DMRS sequence initialization may be calculated as i_{SSB}=(MSB_{3bits}<<3)+LSB_{3bits}.

Additionally, the MIB may include various time-invariant and time-variant fields applicable to 6G, such as the fields shown in Table 2. For example, the time-invariant fields (e.g., static MIB content) may include subCarrierSpacingCommon, ssb-SubcarrierOffset, dmrs-TypeA-Position, pdcch-ConfigSIB1, cellBarred, intraFreqReselection, SSB group size, Num SSB beams, duplex mode, cell identifier (ID)-partial, periodic CSI-RS info or TRS info, CSI reporting, cluster periodicity, and so forth. The time-variant fields (e.g., dynamic MIB content) may include an SFN, a half-frame indicator, an SSB index, PBCH DMRS scrambling, and so forth.

TABLE 2
Time-variant and time-invariant information for 6G

| | Number | | |
|---|---|---|---|
| | of bits | | Update rate |
| 6GR Static MIB content | | | |
| subCarrierSpacingCommon | 1 | bit | NO - static cell parameter |
| ssb-SubcarrierOffset | 4 | bits | NO - static cell parameter |
| dmrs-TypeA-Position | 1 | bit | NO - static cell parameter |
| pdcch-ConfigSIB1 | 8 | bits | NO - quasi-static |
| cellBarred | 1 | bit | NO - quasi-static |
| intraFreqReselection | 1 | bit | NO - quasi-static |
| SSB group size | 5 | bits | NO - quasi-static |
| Num SSB beams | 2 | bits | NO - quasi-static |
| Duplex mode | 4 | bits | NO - quasi-static |
| Cell ID - partial | 8 | bits | Never |
| Periodic CSI-RS info | 7 | bits | NO - quasi-static |
| or TRS info | | | |
| CSI reporting | 2 | bit | NO - quasi-static |
| Cluster periodicity | 2 | bits | NO - quasi-static |
| | Total bits = | | |
| 6GR Dynamic MIB content | | | |
| System frame number | 10 | bits | Every 10 ms |
| Half frame indicator | 1 | bit | Every 5 ms |
| SSB index | 6 | bits | Every occasion |

Total bits =

In some implementations, the SSB structure 200 may integrate the PBCH 206 (e.g., the PBCH-S) and the PBCH 212 (e.g., PBCH-D) to transmit the time-invariant information and time-variant information, respectively. The NE may use a first set of multiple time-frequency resources, including a first set of multiple symbols and frequency resources, to transmit the time-invariant information via the PBCH 206, and a second set of multiple time-frequency resources, including a second set of multiple symbols and frequency resources, to transmit the time-variant information via the PBCH 212. In some implementations, the time-invariant information may be multiplexed (e.g., FDMed) with the second payload in a same set of symbols. That is, the PBCH 212 may be FDM with an SSB or the PBCH 206 in the same symbols, enabling simultaneous transmission of both payloads within the same time resources while occupying different frequency resources. Additionally, or alternatively, the NE may transmit a set of multiple instances of the second payload at an end of an SSB burst, where a first instance of the second payload may be associated with a first SSB beam and a first SSB occasion (or a set of SSB beams and SSB occasions) and a second instance of the second payload may be associated with a second SSB beam and a second SSB occasion (or a set of SSB beams and SSB occasions). The UE may use a mapping formula to determine a relative first symbol starting location of the PBCH 212 from that of the corresponding SSB(s) using time domain offsets and beam indices, similar to the determination of SSB to CORESET #0 time domain location.

In some implementations, the PBCH 206 may include an identical payload and a common DMRS scrambling across a set of SSB beams, enabling a UE to perform non-coherent combining of the first payload of time-invariant information received via the set of SSB beams. In such cases, the PBCH 212 may include a second payload of beam-specific or time-variant information for all SSB beams or a subset of beams. In some implementations, the PBCH 212 may indicate an SSB beam index via DMRS scrambling to reduce the payload size for the SSB beam index indication. The PBCH 206 and the PBCH 212 may be coded with different code rates and may use the same channel coding scheme (e.g., polar coding) or different channel coding schemes. For example, the PBCH 206 may use polar coding and the PBCH 212 may use Reed-Muller (RM) codes, enabling optimization of each channel for its respective payload characteristics. The SSB index in the PBCH 212 may correspond to the SSB index transmission of SS/PBCH in each beam. In some implementations, the SSB beam index may be indicated explicitly in the PBCH 212 for all SSB beams in an SSB burst or a subset of SSB beams associated with the beam used to transmit the PBCH 212. In some examples, the NE may indicate an SSB beam index explicitly using a bitmap field or a codepoint field by associating the time domain position of the SSB to that of the bitmap or codepoint. For example, SSB indices for four SSB beams may be associated with a PBCH 212 transmission. In such examples, a first SSB beam index transmitted in a first SSB occasion may be indicated in a first bitmap position or a first codepoint field, a second SSB beam index transmitted in a second SSB occasion may be indicated in a second bitmap position or a second codepoint field in the second channel, and so on for subsequent SSB beams and occasions.

In some implementations, the PBCH 206 may be associated with a DMRS sequence that is initialized based on a cell ID or a portion of the cell ID, such as a PSS ID or an SSS ID. The DMRS sequence initialization based on the cell ID or a portion thereof may enable the UE to perform channel estimation for demodulating the PBCH 206. In some examples, the NE may transmit a PBCH 206 DMRS using one port or two port multiplexing to reduce inter-cell interference, where the port multiplexing configuration may enable spatial diversity or interference mitigation between neighboring cells.

In some implementations, the NE may transmit the PBCH 206 via an anchor beam associated with one or more SSB beams of the set of SSB beams. The anchor beam may correspond to a designated beam within a group of SSB beams that is used for transmitting the time-variant information on behalf of the group. For example, the NE may transmit the PBCH 206 in one anchor beam per group of SSB beams (e.g., one anchor beam per group of four SSB beams), where the anchor beam may be a wider beam than each individual SSB beam in the group. The transmission of the PBCH 206 via the anchor beam may be associated with a relatively lower code rate, which may improve reliability for the time-invariant information through enhanced error correction capability. Additionally, the NE may transmit the PBCH 206 with time domain repetition, where the NE may transmit multiple instances of the time-invariant information to provide additional combining opportunities at the UE and improve decoding reliability in scenarios with constrained link budgets.

In some examples, at the UE side, PBCH 206 DMRSs (e.g., PBCH-S DMRSs) may be identical across all SSB beams and within a same SSB burst set. In such cases, for example, the UE may use a PBCH 206 DMRS associated with a beam #0 to estimate a channel for the PBCH 206 associated with the beam #0; however, the UE may be unable to coherently combine the DMRS associated with the beam #0 DMRS with a DMRS associated with the beam #1 because of different spatial channels (e.g., H_0≠H_1). As such, non-coherent combining at the LLR level may be possible, where the UE is able to compute an LLR for each beam independently and sum the LLRs as LLR_combined=ΣLLR_i.

In some examples, the UE may perform cell selection after decoding cell quality thresholds from an SIBx (e.g., SIB1) and access control information from the SIBx, after decoding the time-invariant information from the PBCH 206 and without waiting for the UE to successfully decode the time-variant information in the same frame to perform cell selection.

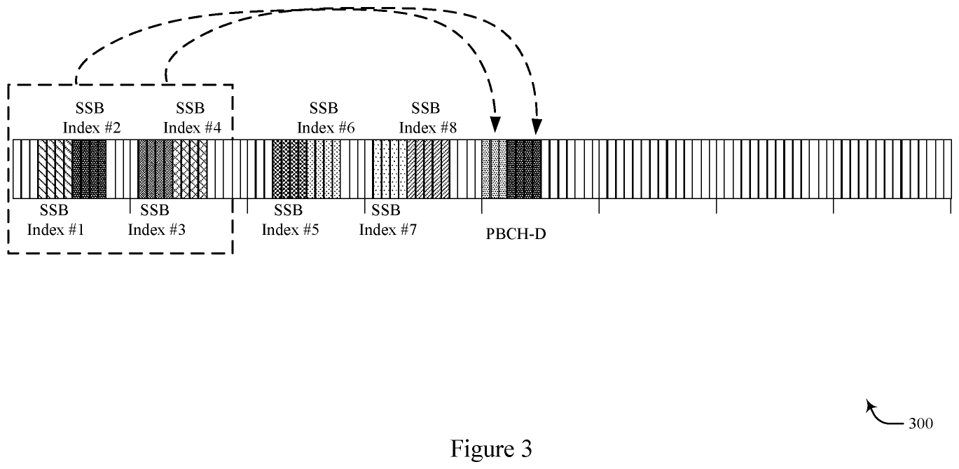

FIG. 3 illustrates an example of an SSB structure 300 in accordance with aspects of the present disclosure. The SSB structure 300 may implement or be implemented by aspects of one or more of the wireless communications system 100 and the SSB structure 200. As described herein with reference to the SSB structure 200 of FIG. 2, the SSB structure 300 may support various synchronization signals, such as PSSs and SSSs, in addition to a PBCH-S, which may be an example of the PBCH 206 of FIG. 2, and a PBCH-D, which may be an example of the PBCH 212 of FIG. 2.

As described herein, time-variant information (e.g., one or more time-variant fields) of an MIB may be removed from the MIB and separately transmitted in a channel (e.g., a PBCH), in an anchor beam, or a combination thereof. That is, the PBCH may carry only remaining time-invariant information (e.g., one or more time-invariant fields) with common DMRS across a group of beams to enable cross-beam combining. The NE may then transmit the time-variant fields in a separate channel or signal with a lower code rate (e.g., 1/15 in a wider beam).

In some examples, as the PBCH-D carries beam-specific and time-variant information, the UE may be unable to perform cross-beam combination of the first and second payloads carried in the PBCH-S and the PBCH-D, respectively. As such, to handle transmission of the time-variant information efficiently, the UE may employ several methods as described herein.

In some implementations, the NE may transmit the time-variant information (e.g., the second payload) via an anchor beam associated with one or more SSB beams of a set of SSB beams. An anchor beam refers to a designated beam within a group of SSB beams that carries the second payload, including time-variant information, for the group. The NE may transmit the time-variant information only in the anchor beam, considering transmission for a group of SSB beams (e.g., one anchor beam per group of four SSB beams), meaning the anchor beam may be a wider beam with a lower code rate than the first channel. The MIB may provide information on beam grouping to enable the UE to determine which anchor beam is associated with a particular SSB beam. As illustrated in the SSB structure 300 of FIG. 3, multiple SSB indices (e.g., SSB index #1 through SSB index #8) may be organized into groups. In this example, the SSB index #7 and SSB index #8 may be associated with a common second payload transmission in the PBCH-D.

In some implementations, the same anchor beam index may be transmitted in each of the first payload beams (e.g., PBCH-S beams) associated with the anchor beam, which the UE may use for cross-beam combining. The second payload (e.g., time-variant information) may indicate a non-anchor SSB beam index using a mapping association between an SSB beam, an SSB occasion, and a bitmap field or a codepoint field in the second payload. In some cases, the anchor beam may be determined based on an SSB index and a beam group size, where a beam group size may refer to the number of SSB beams that share a common anchor beam for receiving the second payload. For example, the anchor beam index may be implicitly derived as anchor beam index=floor(SSB_index/beamGroupSize).

By way of example, the NE may transmit the second payload only on a group anchor beam (e.g., one per group of four SSB beams). In a first group (Group 0), SSB index #0 may be the anchor beam and may carry both the first payload (e.g., PBCH-S) and the second payload (e.g., PBCH-D) with full information, while SSB index #1, SSB index #2, and SSB index #3 may carry the first payload with reduced overhead. In a second group (Group 1), SSB index #4 may be the anchor beam and may carry both the first payload and the second payload, while SSB index #5, SSB index #6, and SSB index #7 may carry only the first payload. In another example, SSB index #3 may also be an anchor beam that carries both the first payload and the second payload with full information.

In some implementations, the UE may decode the first payload from any beam to obtain a static configuration for the time-invariant information. Then, the UE may determine the group anchor from the SSB index (e.g., floor(idx/4)×4), and then the UE may wait for the anchor beam and decode the second payload to obtain an SFN and timing information. In this way, the UE may acquire full system information.

In another implementation, the UE may receive the second payload (e.g., time-variant information) at an end of an SSB burst set via a wider beam than a beam used for reception of the first payload (e.g., time-invariant information). An SSB burst set may refer to a collection of SSB transmissions within a defined time period. The second payload may be associated with the burst set at the end of the burst set and may be transmitted using a wider beam and repetition. As illustrated in the SSB structure 300 of FIG. 3, the NE may transmit the second payload in the PBCH-D at the end of an SSB burst. In such cases, the UE may decode the first payload (e.g., using a narrow beam in their serving direction). The UE may then switch to a quasi-omni reception mode for a single second payload transmission to obtain timing-specific frame information (e.g., SFN), which may be common for the SSB burst. A quasi-omni reception mode may refer to a reception configuration in which the UE uses a wider receive beam pattern to receive signals from multiple directions.

In another implementation, the UE may receive the time-variant information via a SIB. In such cases, the second payload information fields may be piggybacked in an SIB including other information such as cell quality information, access control information, paging information, and so forth. In some cases, instead of transmitting a full SFN in the second payload, the NE may transmit a reference SFN in the first payload, and the second payload may carry only a delta SFN (ASFN) including a reduced number of bits. For example, the first payload transmitted via the PBCH-S may carry eight MSBs of the SFN, and the second payload transmitted via the PBCH-D may carry two LSBs of the SFN.

In some implementations, the NE may transmit the time-variant information by reusing a physical downlink control channel (PDCCH)-like channel and the time-invariant information via the PBCH-S. The NE may configure a search monitoring occasion and periodicity and a radio network temporary identifier (RNTI) in the first payload, and the NE may transmit the time-variant information in a common CORESET (e.g., CORESET #0).

In some implementations related to SIB transmission, each SSB beam may still carry the MIB but may point to its group's CORESET #0 and common search space. For example, the SSB index #0, SSB index #1, SSB index #2, and SSB index #3 may all carry identical pdcch-ConfigSIB1 pointing to Group 0 resources for an SIB1 transport block (TB) corresponding to Group 0, which the NE may transmit using a wider beam. The NE may configure the mapping such that Group 0 (SSB index #0, SSB index #1, SSB index #2, and SSB index #3) may map to CORESET #0_G0, then to CSS0_G0, and then to SIB1 TB_G0 transmitted via a wide beam W0. Similarly, Group 1 (SSB index #4, SSB index #5, SSB index #6, and SSB index #7) may map to CORESET #0_G1, then to CSS0_G1, and then to SIB1 TB_G1 transmitted via a wide beam W1.

A field may distinguish SSBs that belong to a group sharing one SIB1. Any pointer to a group-common CORESET #0 may include a timing offset relative to the group anchor SSB (e.g., the lowest SSB index) or the last SSB within a group. A new field (e.g., ssb-GroupAnchorOffset) may be included in the MIB, or SSB anchor group membership may be defined implicitly from the SSB index. For example, a Group ID may be calculated as floor(SSB_index/GroupSize), an anchor SSB may be calculated as Group ID×GroupSize (always the lowest SSB index in the group), and an offset in group may be calculated as SSB_index mod GroupSize.

For beam grouping, the monitoring occasion of CORESET #0 may be anchored to the group's anchor SSB. The timing may be calculated as t_group_g=t_SSB_anchor_g+Δ_group(searchSpaceZero, g), where t_SSB_anchor_g may be the transmission time of the anchor SSB (e.g., SSB #(4g)) of group g, and Δ_group may be the slot offset from the anchor SSB to the group CORESET #0/CSS0. Additional searchSpaceZero table entries may be used to encode the anchor-relative offset Δ_group, which may be greater than or equal to (3×SSB_duration+processing_time) to ensure all group SSBs are transmitted before the CORESET #0 occasion. A combination of the implementations and examples described herein may be implemented for both the second payload (e.g., PBCH-D) and SIB1.

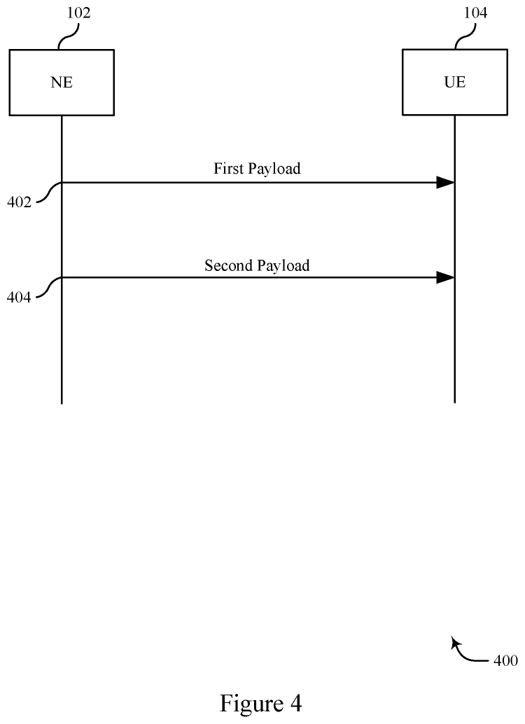

FIG. 4 illustrates an example of a signaling diagram 400 in accordance with aspects of the present disclosure. In some examples, the signaling diagram 400 implements or is implemented by aspects of one or more of the wireless communications system 100, the SSB structure 200, and the SSB structure 300. The signaling diagram 400 may implement or be implemented by an NE 102 and a UE 104, which may be examples of the corresponding devices as described with reference to FIGS. 1 through 3. Alternative examples of the following may be implemented, where some processes are performed in a different order than described or are not performed. In some cases, processes may include additional features not mentioned below, or further processes may be added.

At 402, the NE 102 may transmit a first payload 402 to the UE 104. The first payload 402 may include time-invariant information associated with an MIB. The NE 102 may transmit the first payload 402 via a first channel (e.g., a PBCH-S), where the first channel may be associated with a DMRS that is common for a set of SSB beams. The NE 102 may transmit the first payload 402 in each beam of the set of SSB beams. In some implementations, the UE 104 may receive the first payload 402 using a first set of multiple time-frequency resources based on an SSB structure. In some implementations, the first channel may be frequency division multiplexed (FDM) with a second channel in the same set of symbols. The use of a common DMRS across the set of SSB beams may enable the UE 104 to perform non-coherent combining of the first payload 402 received via the set of SSB beams, which may improve decoding reliability and extend coverage. In some implementations, the UE 104 may perform cell selection based on the time-invariant information without decoding time-variant information, reducing latency during initial access procedures.

At 404, the NE 102 may transmit a second payload 404 to the UE 104. The second payload 404 may include time-variant information associated with the MIB. The time-variant information may include at least one of an SFN, a half-frame indicator, an SSB index, or the like. The NE 102 may transmit the second payload 404 via a second channel (e.g., a PBCH-D). In some implementations, the UE 104 may receive the second payload 404 using a second set of multiple time-frequency resources based on the SSB structure. In some implementations, the UE 104 may receive a set of multiple instances of the second payload 404 at the end of an SSB burst, where a first instance of the second payload 404 may be associated with a first SSB beam and a first SSB occasion and a second instance of the second payload 404 may be associated with a second SSB beam and a second SSB occasion.

In some implementations, the UE 104 may receive the second payload 404 via an anchor beam associated with one or more SSB beams of the set of SSB beams. The UE 104 may determine the anchor beam based on an SSB index and a beam group size. In some implementations, the UE 104 may receive the second payload 404 at the end of an SSB burst set via a wider beam than a beam used for reception of the first payload 402. In such cases, the UE 104 may decode the time-invariant information based on receiving the first payload 402 and switch to a quasi-omni reception mode to receive the second payload 404.

In some implementations, the UE 104 may receive the time-variant information via an SIB, where the SIB may further include at least one of cell quality information, access control information, or paging information. In some implementations, the first channel and the second channel may be coded with different code rates and different channel coding schemes. In some implementations, the second channel may be associated with a lower code rate than the first channel, which may improve reliability for the time-variant information through enhanced error correction capability. In some implementations, the second channel may indicate an SSB beam index for the set of SSB beams via a bitmap field or a codepoint field. In some implementations, the UE 104 may receive, via the set of SSB beams, a configuration indicating a CORESET common to the set of SSB beams. The UE 104 may receive an SIB via the CORESET, where the SIB may be received in a beam that is wider than the set of SSB beams.

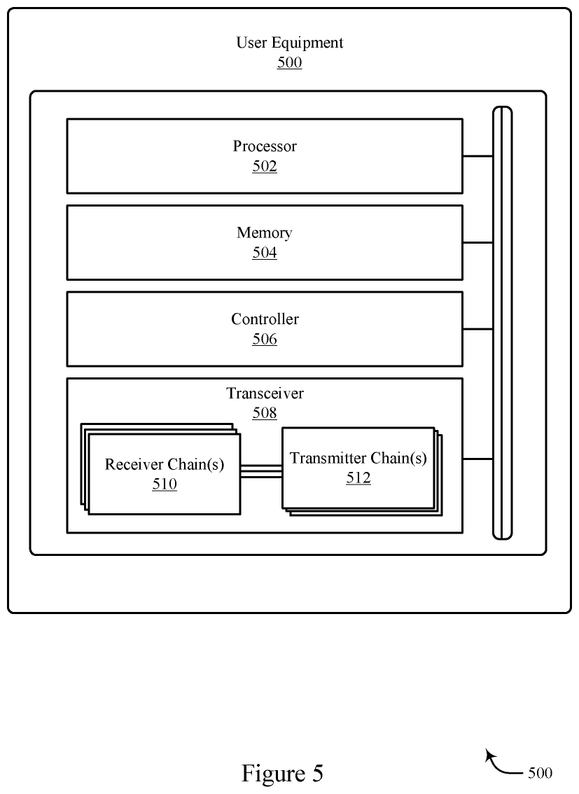

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof, configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502 cause the UE 500 to perform various functions described herein. The code may be stored in a non-transitory computer-readable medium such as the memory 504 or another type of memory. Computer-readable media include both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving, via a first channel, a first payload including time-invariant information associated with an MIB, where the first channel is associated with a DMRS that is common for a set of SSB beams, and where the first payload is transmitted in each beam of the set of SSB beams, and receiving, via a second channel, a second payload including time-variant information associated with the MIB, where the second payload is transmitted in at least one of a subset of the set of SSB beams, a beam wider than each beam of the set of SSB beams, or a number of repetitions. In this manner, the UE 500 supports improved coverage and reduced decoding complexity by enabling non-coherent combining of time-invariant information across multiple beams while efficiently receiving time-variant information via optimized transmission schemes.

Additionally, the UE 500 may be configured to support any one or combination of the following. For example, the UE 500 may be configured to or be operable to support where a first set of multiple time-frequency resources are used to receive the first payload and a second set of multiple time-frequency resources are used to receive the second payload based on an SSB structure. This aspect contributes to the improved coverage and reduced decoding complexity by enabling efficient resource allocation for the separate transmission of time-invariant and time-variant information within the SSB framework at the UE 500. Additionally, or alternatively, the UE 500 may be configured to or be operable to support where the first payload is FDM with the second payload in a same set of symbols. This aspect contributes to the improved coverage and reduced decoding complexity by enabling simultaneous reception of both payloads within the same time resources, improving spectral efficiency at the UE 500. Additionally, or alternatively, the UE 500 may be configured to or be operable to support receiving a set of multiple instances of the second payload at an end of an SSB burst, where a first instance of the second payload is associated with a first SSB beam and a first SSB occasion and a second instance of the second payload is associated with a second SSB beam and a second SSB occasion. This aspect contributes to the improved coverage and reduced decoding complexity by enabling the UE 500 to receive time-variant information associated with different beams in a consolidated manner, reducing reception latency. Additionally, or alternatively, the UE 500 may be configured to or be operable to support performing non-coherent combining of the first payload received via the set of SSB beams based on the DMRS being common for the set of SSB beams. This aspect contributes to the improved coverage and reduced decoding complexity by improving decoding reliability and extending coverage through combining signals received across multiple beams at the UE 500. Additionally, or alternatively, the UE 500 may be configured to or be operable to support where the second payload is received via an anchor beam associated with one or more SSB beams of the set of SSB beams. This aspect contributes to the improved coverage and reduced decoding complexity by reducing overhead through transmitting time-variant information via a subset of beams at the UE 500. Additionally, or alternatively, the UE 500 may be configured to or be operable to support determining the anchor beam based on an SSB index and a beam group size. This aspect contributes to the improved coverage and reduced decoding complexity by enabling the UE 500 to efficiently identify the appropriate beam for receiving time-variant information, reducing processing latency.

Additionally, or alternatively, the UE 500 may be configured to or operable to support where the second payload is received at an end of an SSB burst set via a wider beam than a beam used for reception of the first payload. This aspect contributes to the improved coverage and reduced decoding complexity by enabling reception of time-variant information with enhanced coverage using a wider beam at the UE 500. Additionally, or alternatively, the UE 500 may be configured to or operable to support decoding the time-invariant information based on receiving the first payload and switching to a quasi-omni reception mode to receive the second payload. This aspect contributes to the improved coverage and reduced decoding complexity by enabling the UE 500 to optimize reception for each payload type, improving overall reception reliability. Additionally, or alternatively, the UE 500 may be configured to or operable to support receiving the time-variant information via an SIB, and where the SIB further includes at least one of cell quality information, access control information, or paging information. This aspect contributes to the improved coverage and reduced decoding complexity by enabling the UE 500 to receive additional system information along with the time-variant information, improving throughput efficiency. Additionally, or alternatively, the UE 500 may be configured to or operable to support performing cell selection based on the time-invariant information without decoding the time-variant information. This aspect contributes to the improved coverage and reduced decoding complexity by reducing latency during initial access through enabling cell selection without waiting for time-variant information at the UE 500. Additionally, or alternatively, the UE 500 may be configured to or operable to support where the first channel and the second channel are coded with different code rates and different channel coding schemes. This aspect contributes to the improved coverage and reduced decoding complexity by enabling optimization of each channel for its respective payload characteristics, improving overall decoding reliability at the UE 500. Additionally, or alternatively, the UE 500 may be configured to or operable to support where the time-variant information includes at least one of an SFN, a half-frame indicator, or an SSB index. This aspect contributes to the improved coverage and reduced decoding complexity by enabling the UE 500 to receive timing-related information that may change frequently, while maintaining efficient transmission of static configuration parameters. Additionally, or alternatively, the UE 500 may be configured to or operable to support where the second channel indicates an SSB beam index for the set of SSB beams via a bitmap field or a codepoint field. This aspect contributes to the improved coverage and reduced decoding complexity by enabling the UE 500 to efficiently identify the beam associated with the received time-variant information, reducing processing overhead. Additionally, or alternatively, the UE 500 may be configured to or operable to support receiving, via the set of SSB beams, a configuration indicating a CORESET common to the set of SSB beams and receiving an SIB via the CORESET, where the SIB is received in a beam that is wider than the set of SSB beams. This aspect contributes to the improved coverage and reduced decoding complexity by enabling efficient reception of system information via a common CORESET, reducing signaling overhead at the UE 500. Additionally, or alternatively, the UE 500 may be configured to or operable to support where the second channel is associated with a lower code rate than the first channel. This aspect contributes to the improved coverage and reduced decoding complexity by improving reliability for the time-variant information through enhanced error correction capability at the UE 500.

Additionally, or alternatively, the UE 500 may support at least one memory (e.g., the memory 504) and at least one processor (e.g., the processor 502) coupled with the at least one memory and configured to cause the UE to receive, via a first channel, a first payload including time-invariant information associated with an MIB, where the first channel is associated with a DMRS that is common for a set of SSB beams, and where the first payload is transmitted in each beam of the set of SSB beams, and receive, via a second channel, a second payload including time-variant information associated with the MIB, where the second payload is transmitted in at least one of a subset of the set of SSB beams, a beam wider than each beam of the set of SSB beams, or a number of repetitions. In this manner, the UE 500 supports improved coverage and reduced decoding complexity by enabling non-coherent combining of time-invariant information across multiple beams while efficiently receiving time-variant information via optimized transmission schemes.

Additionally, the UE 500 may be configured to support any one or combination of the following. For example, the UE 500 may be configured to or operable to support where a first set of multiple time-frequency resources are used to receive the first payload and a second set of multiple time-frequency resources are used to receive the second payload based on an SSB structure. This aspect contributes to the improved coverage and reduced decoding complexity by enabling efficient resource allocation for the separate transmission of time-invariant and time-variant information within the SSB framework at the UE 500. Additionally, or alternatively, the UE 500 may be configured to or operable to support where the first payload is FDM with the second payload in a same set of symbols. This aspect contributes to the improved coverage and reduced decoding complexity by enabling simultaneous reception of both payloads within the same time resources, improving spectral efficiency at the UE 500. Additionally, or alternatively, the UE 500 may be configured to or operable to support receiving a set of multiple instances of the second payload at an end of an SSB burst, where a first instance of the second payload is associated with a first SSB beam and a first SSB occasion and a second instance of the second payload is associated with a second SSB beam and a second SSB occasion. This aspect contributes to the improved coverage and reduced decoding complexity by enabling the UE 500 to receive time-variant information associated with different beams in a consolidated manner, reducing reception latency. Additionally, or alternatively, the UE 500 may be configured to or operable to support performing non-coherent combining of the first payload received via the set of SSB beams based on the DMRS being common for the set of SSB beams. This aspect contributes to the improved coverage and reduced decoding complexity by improving decoding reliability and extending coverage through combining signals received across multiple beams at the UE 500. Additionally, or alternatively, the UE 500 may be configured to or operable to support where the second payload is received via an anchor beam associated with one or more SSB beams of the set of SSB beams. This aspect contributes to the improved coverage and reduced decoding complexity by reducing overhead through transmitting time-variant information via a subset of beams at the UE 500. Additionally, or alternatively, the UE 500 may be configured to or operable to support determining the anchor beam based on an SSB index and a beam group size. This aspect contributes to the improved coverage and reduced decoding complexity by enabling the UE 500 to efficiently identify the appropriate beam for receiving time-variant information, reducing processing latency.

Additionally, or alternatively, the UE 500 may be configured to or be operable to support where the second payload is received at an end of an SSB burst set via a wider beam than a beam used for reception of the first payload. This aspect contributes to the improved coverage and reduced decoding complexity by enabling reception of time-variant information with enhanced coverage using a wider beam at the UE 500. Additionally, or alternatively, the UE 500 may be configured to or be operable to support decoding the time-invariant information based on receiving the first payload and switching to a quasi-omni reception mode to receive the second payload. This aspect contributes to the improved coverage and reduced decoding complexity by enabling the UE 500 to optimize reception for each payload type, improving overall reception reliability.

Additionally, or alternatively, the UE 500 may be configured to or be operable to support receiving the time-variant information via an SIB, and where the SIB further includes at least one of cell quality information, access control information, or paging information. This aspect contributes to the improved coverage and reduced decoding complexity by enabling the UE 500 to receive additional system information along with the time-variant information, improving throughput efficiency. Additionally, or alternatively, the UE 500 may be configured to or be operable to support performing cell selection based on the time-invariant information without decoding the time-variant information. This aspect contributes to the improved coverage and reduced decoding complexity by reducing latency during initial access through enabling cell selection without waiting for time-variant information at the UE 500. Additionally, or alternatively, the UE 500 may be configured to or be operable to support where the first channel and the second channel are coded with different code rates and different channel coding schemes. This aspect contributes to the improved coverage and reduced decoding complexity by enabling optimization of each channel for its respective payload characteristics, improving overall decoding reliability at the UE 500. Additionally, or alternatively, the UE 500 may be configured to or be operable to support where the time-variant information includes at least one of an SFN, a half-frame indicator, or an SSB index. This aspect contributes to the improved coverage and reduced decoding complexity by enabling the UE 500 to receive timing-related information that may change frequently, while maintaining efficient transmission of static configuration parameters. Additionally, or alternatively, the UE 500 may be configured to or be operable to support where the second channel indicates an SSB beam index for the set of SSB beams via a bitmap field or a codepoint field. This aspect contributes to the improved coverage and reduced decoding complexity by enabling the UE 500 to efficiently identify the beam associated with the received time-variant information, reducing processing overhead. Additionally, or alternatively, the UE 500 may be configured to or be operable to support receiving, via the set of SSB beams, a configuration indicating a CORESET common to the set of SSB beams and receiving an SIB via the CORESET, where the SIB is received in a beam that is wider than the set of SSB beams. This aspect contributes to the improved coverage and reduced decoding complexity by enabling efficient reception of system information via a common CORESET, reducing signaling overhead at the UE 500. Additionally, or alternatively, the UE 500 may be configured to or be operable to support where the second channel is associated with a lower code rate than the first channel. This aspect contributes to the improved coverage and reduced decoding complexity by improving reliability for the time-variant information through enhanced error correction capability at the UE 500.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or a wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or a wireless medium.

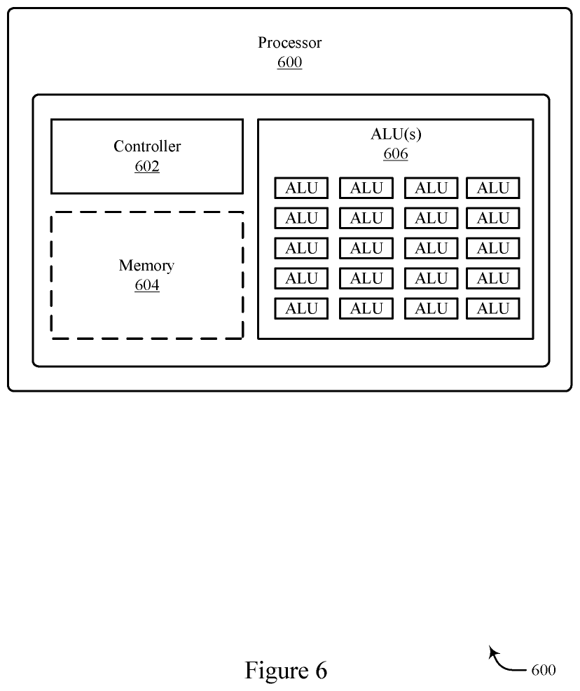

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage the flow of data within the processor 600. The controller 602 may be configured to control the transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc.). In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive, via a first channel, a first payload including time-invariant information associated with an MIB, where the first channel is associated with a DMRS that is common for a set of SSB beams, and where the first payload is transmitted in each beam of the set of SSB beams, and receive, via a second channel, a second payload including time-variant information associated with the MIB, where the second payload is transmitted in at least one of a subset of the set of SSB beams, a beam wider than each beam of the set of SSB beams, or a number of repetitions. In this manner, the processor 600 supports improved coverage and reduced decoding complexity by enabling non-coherent combining of time-invariant information across multiple beams while efficiently receiving time-variant information via optimized transmission schemes.

Additionally, the processor 600 may be configured to support any one or combination of the following. For example, the processor 600 may be configured to or operable to support where a first set of multiple time-frequency resources are used to receive the first payload and a second set of multiple time-frequency resources are used to receive the second payload based on an SSB structure. This aspect contributes to the improved coverage and reduced decoding complexity by enabling efficient resource allocation for the separate transmission of time-invariant and time-variant information within the SSB framework at the processor 600. Additionally, or alternatively, the processor 600 may be configured to or operable to support where the first payload is FDM with the second payload in a same set of symbols. This aspect contributes to the improved coverage and reduced decoding complexity by enabling simultaneous reception of both payloads within the same time resources, improving spectral efficiency at the processor 600. Additionally, or alternatively, the processor 600 may be configured to or operable to support receiving a set of multiple instances of the second payload at an end of an SSB burst, where a first instance of the second payload is associated with a first SSB beam and a first SSB occasion and a second instance of the second payload is associated with a second SSB beam and a second SSB occasion. This aspect contributes to the improved coverage and reduced decoding complexity by enabling the processor 600 to receive time-variant information associated with different beams in a consolidated manner, reducing reception latency. Additionally, or alternatively, the processor 600 may be configured to or operable to support performing non-coherent combining of the first payload received via the set of SSB beams based on the DMRS being common for the set of SSB beams. This aspect contributes to the improved coverage and reduced decoding complexity by improving decoding reliability and extending coverage through combining signals received across multiple beams at the processor 600. Additionally, or alternatively, the processor 600 may be configured to or operable to support where the second payload is received via an anchor beam associated with one or more SSB beams of the set of SSB beams. This aspect contributes to the improved coverage and reduced decoding complexity by reducing overhead through transmitting time-variant information via a subset of beams at the processor 600. Additionally, or alternatively, the processor 600 may be configured to or operable to support determining the anchor beam based on an SSB index and a beam group size. This aspect contributes to the improved coverage and reduced decoding complexity by enabling the processor 600 to efficiently identify the appropriate beam for receiving time-variant information, reducing processing latency.

Additionally, or alternatively, the processor 600 may be configured to or be operable to support where the second payload is received at an end of an SSB burst set via a wider beam than a beam used for reception of the first payload. This aspect contributes to the improved coverage and reduced decoding complexity by enabling reception of time-variant information with enhanced coverage using a wider beam at the processor 600. Additionally, or alternatively, the processor 600 may be configured to or be operable to support decoding the time-invariant information based on receiving the first payload and switching to a quasi-omni reception mode to receive the second payload. This aspect contributes to the improved coverage and reduced decoding complexity by enabling the processor 600 to optimize reception for each payload type, improving overall reception reliability. Additionally, or alternatively, the processor 600 may be configured to or be operable to support receiving the time-variant information via an SIB, and where the SIB further includes at least one of cell quality information, access control information, or paging information. This aspect contributes to the improved coverage and reduced decoding complexity by enabling the processor 600 to receive additional system information along with the time-variant information, improving throughput efficiency. Additionally, or alternatively, the processor 600 may be configured to or be operable to support performing cell selection based on the time-invariant information without decoding the time-variant information. This aspect contributes to the improved coverage and reduced decoding complexity by reducing latency during initial access through enabling cell selection without waiting for time-variant information at the processor 600. Additionally, or alternatively, the processor 600 may be configured to or be operable to support where the first channel and the second channel are coded with different code rates and different channel coding schemes. This aspect contributes to the improved coverage and reduced decoding complexity by enabling optimization of each channel for its respective payload characteristics, improving overall decoding reliability at the processor 600. Additionally, or alternatively, the processor 600 may be configured to or be operable to support where the time-variant information includes at least one of an SFN, a half-frame indicator, or an SSB index. This aspect contributes to the improved coverage and reduced decoding complexity by enabling the processor 600 to receive timing-related information that may change frequently, while maintaining efficient transmission of static configuration parameters. Additionally, or alternatively, the processor 600 may be configured to or be operable to support where the second channel indicates an SSB beam index for the set of SSB beams via a bitmap field or a codepoint field. This aspect contributes to the improved coverage and reduced decoding complexity by enabling the processor 600 to efficiently identify the beam associated with the received time-variant information, reducing processing overhead. Additionally, or alternatively, the processor 600 may be configured to or be operable to support receiving, via the set of SSB beams, a configuration indicating a CORESET common to the set of SSB beams and receiving an SIB via the CORESET, where the SIB is received in a beam that is wider than the set of SSB beams. This aspect contributes to the improved coverage and reduced decoding complexity by enabling efficient reception of system information via a common CORESET, reducing signaling overhead at the processor 600. Additionally, or alternatively, the processor 600 may be configured to or be operable to support where the second channel is associated with a lower code rate than the first channel. This aspect contributes to the improved coverage and reduced decoding complexity by improving reliability for the time-variant information through enhanced error correction capability at the processor 600.

Additionally, the processor 600 may support wireless communication in accordance with examples as disclosed herein. The processor 600 may be configured to or operable to support at least one controller (e.g., the controller 602) coupled with at least one memory (e.g., the memory 604) and configured to cause the processor to transmit, via a first channel, a first payload including time-invariant information associated with an MIB, where the first channel is associated with a DMRS that is common for a set of SSB beams, and where the first payload is transmitted in each beam of the set of SSB beams, and transmit, via a second channel, a second payload including time-variant information associated with the MIB, where the second payload is transmitted in at least one of a subset of the set of SSB beams, a beam wider than each beam of the set of SSB beams, or a number of repetitions. In this manner, the processor 600 supports improved coverage and reduced decoding complexity by enabling non-coherent combining of time-invariant information across multiple beams at a UE while efficiently transmitting time-variant information via optimized transmission schemes.

Additionally, or alternatively, the processor 600 may be configured to support any one or combination of the following. For example, the processor 600 may be configured to or operable to support where a first set of multiple time-frequency resources are used to transmit the first payload and a second set of multiple time-frequency resources are used to transmit the second payload based on an SSB structure. This aspect contributes to the improved coverage and reduced decoding complexity by enabling efficient resource allocation for the separate transmission of time-invariant and time-variant information within the SSB framework at the processor 600. Additionally, or alternatively, the processor 600 may be configured to or operable to support where the first channel is FDM with the second channel in a same set of symbols. This aspect contributes to the improved coverage and reduced decoding complexity by enabling simultaneous transmission of both payloads within the same time resources, improving spectral efficiency at the processor 600. Additionally, or alternatively, the processor 600 may be configured to or operable to support transmitting a set of multiple instances of the second payload at an end of an SSB burst, where a first instance of the second payload is associated with a first SSB beam and a first SSB occasion and a second instance of the second payload is associated with a second SSB beam and a second SSB occasion. This aspect contributes to the improved coverage and reduced decoding complexity by enabling the processor 600 to transmit time-variant information associated with different beams in a consolidated manner, reducing transmission overhead.

Additionally, or alternatively, the processor 600 may be configured to or operable to support where the second payload is transmitted via an anchor beam associated with one or more SSB beams of the set of SSB beams. This aspect contributes to the improved coverage and reduced decoding complexity by reducing overhead through transmitting time-variant information via a subset of beams at the processor 600. Additionally, or alternatively, the processor 600 may be configured to or operable to support where the anchor beam is based on an SSB index and a beam group size. This aspect contributes to the improved coverage and reduced decoding complexity by enabling efficient identification of the appropriate beam for transmitting time-variant information at the processor 600. Additionally, or alternatively, the processor 600 may be configured to or operable to support where the second payload is transmitted at an end of an SSB burst set via a wider beam than a beam used for transmission of the first payload. This aspect contributes to the improved coverage and reduced decoding complexity by enabling transmission of time-variant information with enhanced coverage using a wider beam at the processor 600. Additionally, or alternatively, the processor 600 may be configured to or operable to support transmitting the time-variant information via an SIB, and where the SIB further includes at least one of cell quality information, access control information, or paging information. This aspect contributes to the improved coverage and reduced decoding complexity by enabling the processor 600 to transmit additional system information along with the time-variant information, improving throughput efficiency.

Additionally, or alternatively, the processor 600 may be configured to or operable to support where the first channel and the second channel are coded with different code rates and different channel coding schemes. This aspect contributes to the improved coverage and reduced decoding complexity by enabling optimization of each channel for its respective payload characteristics, improving overall decoding reliability at a receiving UE. Additionally, or alternatively, the processor 600 may be configured to or operable to support where the time-variant information includes at least one of an SFN, a half-frame indicator, or an SSB index. This aspect contributes to the improved coverage and reduced decoding complexity by enabling the processor 600 to transmit timing-related information that may change frequently, while maintaining efficient transmission of static configuration parameters. Additionally, or alternatively, the processor 600 may be configured to or operable to support where the second payload indicates an SSB beam index for the set of SSB beams via a bitmap field or a codepoint field. This aspect contributes to the improved coverage and reduced decoding complexity by enabling a UE to efficiently identify the beam associated with the received time-variant information, reducing processing overhead. Additionally, or alternatively, the processor 600 may be configured to or operable to support transmitting, via the set of SSB beams, a configuration indicating a CORESET common to the set of SSB beams, and transmitting an SIB via the CORESET, where the SIB is transmitted in a beam that is wider than the set of SSB beams. This aspect contributes to the improved coverage and reduced decoding complexity by enabling efficient transmission of system information via a common CORESET, reducing signaling overhead at the processor 600. Additionally, or alternatively, the processor 600 may be configured to or operable to support where the second channel is associated with a lower code rate than the first channel. This aspect contributes to the improved coverage and reduced decoding complexity by improving reliability for the time-variant information through enhanced error correction capability at a receiving UE.

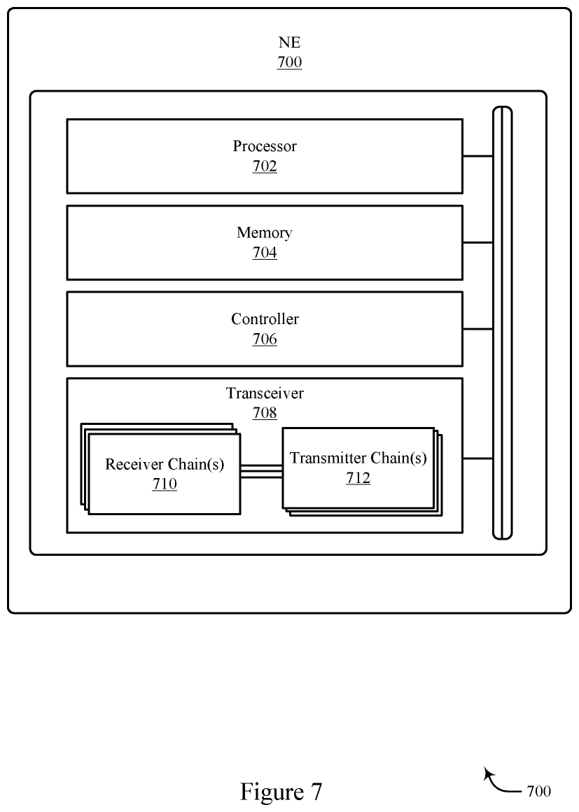

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions that, when executed by the processor 702 cause the NE 700 to perform various functions described herein. The code may be stored in a non-transitory computer-readable medium such as the memory 704 or another type of memory. Computer-readable media include both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting, via a first channel, a first payload including time-invariant information associated with an MIB, where the first channel is associated with a DMRS that is common for a set of SSB beams, and where the first payload is transmitted in each beam of the set of SSB beams, and transmitting, via a second channel, a second payload including time-variant information associated with the MIB, where the second payload is transmitted in at least one of a subset of the set of SSB beams, a beam wider than each beam of the set of SSB beams, or a number of repetitions. In this manner, the NE 700 supports improved coverage and reduced decoding complexity by enabling non-coherent combining of time-invariant information across multiple beams at a UE while efficiently transmitting time-variant information via optimized transmission schemes.

Additionally, the NE 700 may be configured to support any one or combination of the following. For example, the NE 700 may be configured to or operable to support where a first set of multiple time-frequency resources are used to transmit the first payload and a second set of multiple time-frequency resources are used to transmit the second payload based on an SSB structure. This aspect contributes to the improved coverage and reduced decoding complexity by enabling efficient resource allocation for the separate transmission of time-invariant and time-variant information within the SSB framework at the NE 700. Additionally, or alternatively, the NE 700 may be configured to or operable to support where the first channel is FDM with the second channel in a same set of symbols. This aspect contributes to the improved coverage and reduced decoding complexity by enabling simultaneous transmission of both payloads within the same time resources, improving spectral efficiency at the NE 700. Additionally, or alternatively, the NE 700 may be configured to or operable to support transmitting a set of multiple instances of the second payload at an end of an SSB burst, where a first instance of the second payload is associated with a first SSB beam and a first SSB occasion and a second instance of the second payload is associated with a second SSB beam and a second SSB occasion. This aspect contributes to the improved coverage and reduced decoding complexity by enabling the NE 700 to transmit time-variant information associated with different beams in a consolidated manner, reducing transmission overhead.

Additionally, or alternatively, the NE 700 may be configured to or operable to support where the second payload is transmitted via an anchor beam associated with one or more SSB beams of the set of SSB beams. This aspect contributes to the improved coverage and reduced decoding complexity by reducing overhead through transmitting time-variant information via a subset of beams at the NE 700. Additionally, or alternatively, the NE 700 may be configured to or operable to support where the anchor beam is based on an SSB index and a beam group size. This aspect contributes to the improved coverage and reduced decoding complexity by enabling efficient identification of the appropriate beam for transmitting time-variant information at the NE 700. Additionally, or alternatively, the NE 700 may be configured to or operable to support where the second payload is transmitted at an end of an SSB burst set via a wider beam than a beam used for transmission of the first payload. This aspect contributes to the improved coverage and reduced decoding complexity by enabling transmission of time-variant information with enhanced coverage using a wider beam at the NE 700. Additionally, or alternatively, the NE 700 may be configured to or operable to support transmitting the time-variant information via an SIB, and where the SIB further includes at least one of cell quality information, access control information, or paging information. This aspect contributes to the improved coverage and reduced decoding complexity by enabling the NE 700 to transmit additional system information along with the time-variant information, improving throughput efficiency. Additionally, or alternatively, the NE 700 may be configured to or operable to support where the first channel and the second channel are coded with different code rates and different channel coding schemes. This aspect contributes to the improved coverage and reduced decoding complexity by enabling optimization of each channel for its respective payload characteristics, improving overall decoding reliability at a receiving UE. Additionally, or alternatively, the NE 700 may be configured to or operable to support where the time-variant information includes at least one of an SFN, a half-frame indicator, or an SSB index. This aspect contributes to the improved coverage and reduced decoding complexity by enabling the NE 700 to transmit timing-related information that may change frequently, while maintaining efficient transmission of static configuration parameters. Additionally, or alternatively, the NE 700 may be configured to or operable to support where the second payload indicates an SSB beam index for the set of SSB beams via a bitmap field or a codepoint field. This aspect contributes to the improved coverage and reduced decoding complexity by enabling a UE to efficiently identify the beam associated with the received time-variant information, reducing processing overhead.

Additionally, or alternatively, the NE 700 may be configured to or operable to support transmitting, via the set of SSB beams, a configuration indicating a CORESET common to the set of SSB beams, and transmitting an SIB via the CORESET, where the SIB is transmitted in a beam that is wider than the set of SSB beams. This aspect contributes to the improved coverage and reduced decoding complexity by enabling efficient transmission of system information via a common CORESET, reducing signaling overhead at the NE 700. Additionally, or alternatively, the NE 700 may be configured to or operable to support where the second channel is associated with a lower code rate than the first channel. This aspect contributes to the improved coverage and reduced decoding complexity by improving reliability for the time-variant information through enhanced error correction capability at a receiving UE.

Additionally, or alternatively, the NE 700 may support at least one memory (e.g., the memory 704) and at least one processor (e.g., the processor 702) coupled with the at least one memory and configured to cause the NE to transmit, via a first channel, a first payload including time-invariant information associated with an MIB, where the first channel is associated with a DMRS that is common for a set of SSB beams, and where the first payload is transmitted in each beam of the set of SSB beams, and transmit, via a second channel, a second payload including time-variant information associated with the MIB, where the second payload is transmitted in at least one of a subset of the set of SSB beams, a beam wider than each beam of the set of SSB beams, or a number of repetitions. In this manner, the NE 700 supports improved coverage and reduced decoding complexity by enabling non-coherent combining of time-invariant information across multiple beams at a UE while efficiently transmitting time-variant information via optimized transmission schemes.

Additionally, the NE 700 may be configured to support any one or combination of the following. For example, the NE 700 may be configured to or operable to support where a first set of multiple time-frequency resources are used to transmit the first payload and a second set of multiple time-frequency resources are used to transmit the second payload based on an SSB structure. This aspect contributes to the improved coverage and reduced decoding complexity by enabling efficient resource allocation for the separate transmission of time-invariant and time-variant information within the SSB framework at the NE 700. Additionally, or alternatively, the NE 700 may be configured to or operable to support where the first channel is FDM with the second channel in a same set of symbols. This aspect contributes to the improved coverage and reduced decoding complexity by enabling simultaneous transmission of both payloads within the same time resources, improving spectral efficiency at the NE 700. Additionally, or alternatively, the NE 700 may be configured to or operable to support transmitting a set of multiple instances of the second payload at an end of an SSB burst, where a first instance of the second payload is associated with a first SSB beam and a first SSB occasion and a second instance of the second payload is associated with a second SSB beam and a second SSB occasion. This aspect contributes to the improved coverage and reduced decoding complexity by enabling the NE 700 to transmit time-variant information associated with different beams in a consolidated manner, reducing transmission overhead.

Additionally, or alternatively, the NE 700 may be configured to or operable to support where the second payload is transmitted via an anchor beam associated with one or more SSB beams of the set of SSB beams. This aspect contributes to the improved coverage and reduced decoding complexity by reducing overhead through transmitting time-variant information via a subset of beams at the NE 700. Additionally, or alternatively, the NE 700 may be configured to or operable to support where the anchor beam is based on an SSB index and a beam group size. This aspect contributes to the improved coverage and reduced decoding complexity by enabling efficient identification of the appropriate beam for transmitting time-variant information at the NE 700. Additionally, or alternatively, the NE 700 may be configured to or operable to support where the second payload is transmitted at an end of an SSB burst set via a wider beam than a beam used for transmission of the first payload. This aspect contributes to the improved coverage and reduced decoding complexity by enabling transmission of time-variant information with enhanced coverage using a wider beam at the NE 700. Additionally, or alternatively, the NE 700 may be configured to or operable to support transmitting the time-variant information via an SIB, and where the SIB further includes at least one of cell quality information, access control information, or paging information. This aspect contributes to the improved coverage and reduced decoding complexity by enabling the NE 700 to transmit additional system information along with the time-variant information, improving throughput efficiency.

Additionally, or alternatively, the NE 700 may be configured to or be operable to support where the first channel and the second channel are coded with different code rates and different channel coding schemes. This aspect contributes to the improved coverage and reduced decoding complexity by enabling optimization of each channel for its respective payload characteristics, improving overall decoding reliability at a receiving UE. Additionally, or alternatively, the NE 700 may be configured to or be operable to support where the time-variant information includes at least one of an SFN, a half-frame indicator, or an SSB index. This aspect contributes to the improved coverage and reduced decoding complexity by enabling the NE 700 to transmit timing-related information that may change frequently, while maintaining efficient transmission of static configuration parameters. Additionally, or alternatively, the NE 700 may be configured to or be operable to support where the second payload indicates an SSB beam index for the set of SSB beams via a bitmap field or a codepoint field. This aspect contributes to the improved coverage and reduced decoding complexity by enabling a UE to efficiently identify the beam associated with the received time-variant information, reducing processing overhead. Additionally, or alternatively, the NE 700 may be configured to or be operable to support transmitting, via the set of SSB beams, a configuration indicating a CORESET common to the set of SSB beams, and transmitting an SIB via the CORESET, where the SIB is transmitted in a beam that is wider than the set of SSB beams. This aspect contributes to the improved coverage and reduced decoding complexity by enabling efficient transmission of system information via a common CORESET, reducing signaling overhead at the NE 700. Additionally, or alternatively, the NE 700 may be configured to or be operable to support where the second channel is associated with a lower code rate than the first channel. This aspect contributes to the improved coverage and reduced decoding complexity by improving reliability for the time-variant information through enhanced error correction capability at a receiving UE.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

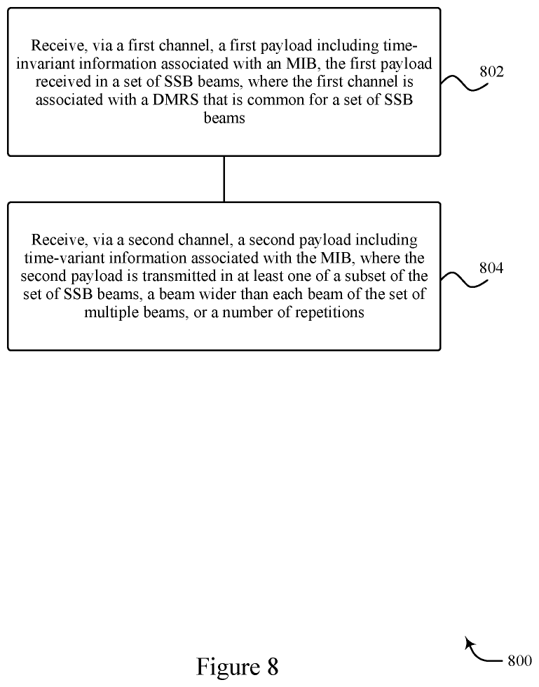

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving, via a first channel, a first payload including time-invariant information associated with an MIB, where the first channel is associated with a DMRS that is common for a set of SSB beams, and where the first payload is transmitted in each beam of the set of SSB beams. The operations of 802 may be performed in accordance with examples as described herein. In some implementations, aspects of the operations of 802 may be performed by a UE as described with reference to FIG. 5.

At 804, the method may include receiving, via a second channel, a second payload including time-variant information associated with the MIB, where the second payload is transmitted in at least one of a subset of the set of SSB beams, a beam wider than each beam of the set of SSB beams, or a number of repetitions. The operations of 804 may be performed in accordance with examples as described herein. In some implementations, aspects of the operations of 804 may be performed by a UE as described with reference to FIG. 5.

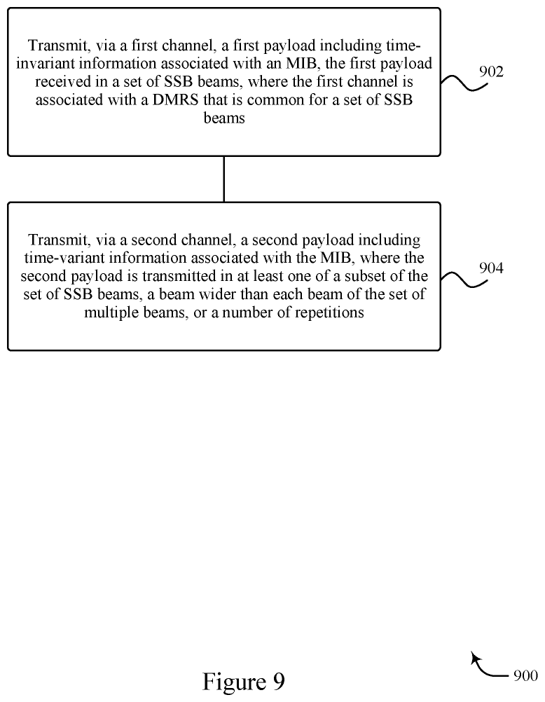

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting, via a first channel, a first payload including time-invariant information associated with an MIB, where the first channel is associated with a DMRS that is common for a set of SSB beams, and where the first payload is transmitted in each beam of the set of SSB beams. The operations of 902 may be performed in accordance with examples as described herein. In some implementations, aspects of the operations of 902 may be performed by an NE as described with reference to FIG. 7.

At 904, the method may include transmitting, via a second channel, a second payload including time-variant information associated with the MIB, where the second payload is transmitted in at least one of a subset of the set of SSB beams, a beam wider than each beam of the set of SSB beams, or a number of repetitions. The operations of 904 may be performed in accordance with examples as described herein. In some implementations, aspects of the operations of 904 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive, via a first channel, a first payload comprising time-invariant information associated with a master information block (MIB), wherein the first channel is associated with a demodulation reference signal (DMRS) that is common for a plurality of beams, and wherein the first payload is transmitted in each beam of the plurality of beams; and
receive, via a second channel, a second payload comprising time-variant information associated with the MIB, wherein the second payload is transmitted in at least one of a subset of the plurality of beams, a beam wider than each beam of the plurality of beams, or a number of repetitions.

2. The UE of claim 1, wherein a first plurality of time-frequency resources are used to receive the first payload and a second plurality of time-frequency resources are used to receive the second payload based at least in part on an SSB structure.

3. The UE of claim 1, wherein the first payload is frequency division multiplexed (FDM) with the second payload in a same set of symbols.

4. The UE of claim 1, wherein the at least one processor is further operable to cause the UE to receive a plurality of instances of the second payload at an end of an SSB burst, wherein a first instance of the second payload is associated with a first SSB beam and a first SSB occasion and a second instance of the second payload is associated with a second SSB beam and a second SSB occasion.

5. The UE of claim 1, wherein the at least one processor is further operable to cause the UE to perform non-coherent combining of the first payload received via the plurality of beams based at least in part on the DMRS being common for the plurality of beams.

6. The UE of claim 1, wherein the second payload is received via an anchor beam associated with one or more SSB beams of the plurality of beams, and wherein the at least one processor is further operable to cause the UE to: determine the anchor beam based at least in part on an SSB index and a beam group size.

7. The UE of claim 1, wherein the second payload is received at an end of an SSB burst set via a wider beam than a beam used for reception of the first payload, and wherein the at least one processor is further operable to cause the UE to:
decode the time-invariant information based at least in part on receiving the first payload; and
switch to a quasi-omni reception mode to receive the second payload.

8. The UE of claim 1, wherein the at least one processor is further operable to cause the UE to receive the time-variant information via a system information block (SIB), and wherein the SIB further comprises at least one of cell quality information, access control information, or paging information.

9. The UE of claim 1, wherein the at least one processor is further operable to cause the UE to perform cell selection based at least in part on the time-invariant information without decoding the time-variant information.

10. The UE of claim 1, wherein the first channel and the second channel are coded with different code rates and different channel coding schemes.

11. The UE of claim 1, wherein the at least one processor is further operable to cause the UE to:
receive, via the plurality of beams, a configuration indicating a control resource set (CORESET) common to the plurality of beams; and
receive a system information block (SIB) via the CORESET, wherein the SIB is received in a beam that is wider than the plurality of beams.

12. A network equipment (NE) for wireless communication, comprising:
at least one memory; and
at least one processor coupled with the at least one memory and operable to cause the NE to:
transmit, via a first channel, a first payload comprising time-invariant information associated with a master information block (MIB), wherein the first channel is associated with a demodulation reference signal (DMRS) that is common for a plurality of beams, and wherein the first payload is transmitted in each beam of the plurality of beams; and
transmit, via a second channel, a second payload comprising time-variant information associated with the MIB, wherein the second payload is transmitted in at least one of a subset of the plurality of beams, a beam wider than each beam of the plurality of beams, or a number of repetitions.

13. The NE of claim 12, wherein a first plurality of time-frequency resources are used to transmit the first payload and a second plurality of time-frequency resources are used to transmit the second payload based at least in part on an SSB structure.

14. The NE of claim 12, wherein the first channel is frequency division multiplexed (FDM) with the second channel in a same set of symbols.

15. The NE of claim 12, wherein the at least one processor is further operable to cause the NE to transmit a plurality of instances of the second payload at an end of an SSB burst, wherein a first instance of the second payload is associated with a first SSB beam and a first SSB occasion and a second instance of the second payload is associated with a second SSB beam and a second SSB occasion.

16. The NE of claim 12, wherein the second payload is transmitted via an anchor beam associated with one or more SSB beams of the plurality of beams, and wherein the anchor beam is based at least in part on an SSB index and a beam group size.

17. The NE of claim 12, wherein the second payload is transmitted at an end of an SSB burst set via a wider beam than a beam used for transmission of the first payload.

18. The NE of claim 12, wherein the at least one processor is further operable to cause the NE to transmit the time-variant information via a system information block (SIB), and wherein the SIB further comprises at least one of cell quality information, access control information, or paging information.

19. A method performed by a user equipment (UE), the method comprising:
receiving, via a first channel, a first payload comprising time-invariant information associated with a master information block (MIB), wherein the first channel is associated with a demodulation reference signal (DMRS) that is common for a plurality of beams, and wherein the first payload is received in each beam of the plurality of beams; and
receiving, via a second channel, a second payload comprising time-variant information associated with the MIB, wherein the second payload is received in at least one of a subset of the plurality of beams, a beam wider than each beam of the plurality of beams, or a number of repetitions.

20. A method performed by a network equipment (NE), the method comprising:
transmitting, via a first channel, a first payload comprising time-invariant information associated with a master information block (MIB), wherein the first channel is associated with a demodulation reference signal (DMRS) that is common for a plurality of beams, and wherein the first payload is transmitted in each beam of the plurality of beams; and
transmitting, via a second channel, a second payload comprising time-variant information associated with the MIB, wherein the second payload is transmitted in at least one of a subset of the plurality of beams, a beam wider than each beam of the plurality of beams, or a number of repetitions.
